(19) United States
(12) Patent Application Publication
(10) Pub. No.: US 2004/0210444 A1
(43) Pub. Date: Oct. 21, 2004

(54) System and method for translating languages using portable display device

(75) Inventors: Robert Thomas Arenburg, Round Rock, TX (US); Franck Barillaud, Austin, TX (US); Bradford Lee Cobb, Cedar Park, TX (US); Gary Roland Hook, Pflugerville, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 10/418,547

(22) Filed: Apr. 17, 2003

(51) Int. Cl. G10L 21/00

(52) U.S. Cl. 704/277

(57) ABSTRACT

A method and system for translating written text from a first (foreign) language to a second (native) language is provided. An image containing the text is first captured at the request of the user. Text zones are identified in the image and the zones are converted to text characters using optical character recognition. The text characters, which are in the first language, are translated to the second language. The translated text is then output to the user. The text may be converted to an image that can be displayed on a display or, alternatively, the text may be synthesized into speech that may be played over a speaker accessible to the user such as an earpiece. Data can be provided to the user as text, audio or text and audio combined.

### BACKGROUND OF THE INVENTION

1. Technical Field

The present invention relates to a system and method for translating written text from a first language to a second language. In particular, the present invention relates to a system and a method of capturing an image of the text in the first language, performing optical character recognition on the image to capture the text, and translating the captured text to the second language.

2. Description of the Related Art

The ability to read and understand text in a foreign language is becoming increasingly important with the increase in tourism as well as the increase in international business. Navigation is hard enough in a country where a traveler speaks the language. Navigation in a country where the traveler does not speak the language is exceedingly difficult.

Matters are even worse in a country where the characters, symbols, and phrases in the alphabet are significantly different from the characters, symbols, and phrases with which a traveler is familiar. For example, an English speaker in France can at least match the letters on a map with the letters seen on a road sign even though the traveler does not speak French. But an English speaker attempting to navigate in China would have a hard time doing even that due to the significant difference in the characters/symbols. Furthermore, in a foreign country the option of asking a local for directions when a traveler does not speak the local language has a very low probability of success.

While eating out at restaurants or shopping in general, a traveler is faced with similar problems. Many tourists often order the wrong items from menus due to their unfamiliarity with the local language. While shopping, tourists may buy the wrong items, pay more than they should, or not buy anything at all due to the lack of communication and the inability to read labels, prices, posted signs, etc.

Problems with perhaps bigger consequences exist for business travelers as well. Navigating efficiently in a foreign country can be crucial not only for getting to an important meeting but also for getting their on time. Being able to read and gain at least a basic understanding of documents in business dealings would certainly increase efficiency and in some situations increase the chances of achieving a favorable business agreement.

What is needed, therefore, is a system and method that could translate text in a foreign language to text in a language chosen by the user. The system and method should provide the user with the capability to translate text found in signs, books, menus, etc. with ease.

### SUMMARY

It has been discovered that the aforementioned challenges can be addressed by a method and system that translates written text from a first (foreign) language to a second (familiar) language. An image containing the text is captured, and the image is converted to text using optical character recognition (OCR). The recognized text is then translated to the second language.

An image containing the text is captured at the request of the user. Text zones are then identified in the image. The text zones may be determined by receiving user input indicating the zones or the zones may be determined by performing pattern recognition on the captured image. The pattern recognition searches for alphanumeric patterns in the image. Optical character recognition (OCR) is performed on the identified text zones to convert the textual images to text characters in digital format.

The text characters, which are in the first language, are then translated to the second language. The first language may be identified by receiving user input indicating the identity of the language. Alternatively, the first language may be identified by comparing the recognized text characters to one or more language profiles. The language is identified when a match occurs between the text characters and the language profile. The recognized text characters are then translated to the second language. Typically the second language is either built-in to the particular system or is chosen by the user. The recognized text characters may be translated by locating a translation of each word, character, or phrase of the first language in a first language-to-second language foreign language dictionary. The translated text may also be saved in storage.

The translated text is then output to the user. The text may be converted to an image that can be displayed on a display that is accessible to the user. Alternatively, the text may be synthesized into speech by using text-to-speech profiles of the second language. In addition, the user can choose to receive both a display of the translated text as well as audio in the form of synthesized speech. The generated speech may be then converted to audio and played over a speaker, such as an earpiece, accessible to the user. A portable translation device is word by the user for both capturing text using a video camera and for receiving both translated text and synthesized speech.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood and its numerous objects, features, and advantageous made apparent to those skilled in the art by referencing the accompanying drawings. The use of the same reference symbols in different drawings indicates similar or identical items.

FIG. 1A is diagram of an example of a portable eyeglass system for translating text in a first (foreign) language to a second (native) language;

FIG. 1B is picture of an example of a portable eyeglass system for translating text in a first (foreign) language to a second (native) language;

FIG. 2 is a high-level block diagram of a language translation system;

FIG. 3 is a flowchart for converting a captured image to text and for determining the language of the captured text;

FIG. 4 is a flowchart for determining text zones in a captured image and for performing OCR on the text zones to obtain text characters;

FIG. 5 is a flowchart for translating captured text in a determined first language to text in a known second language;

FIG. 6 is a flowchart for synthesizing the translated text to speech and then analog audio; and

FIG. 7 illustrates an information handling system which is a simplified example of a computer system capable of performing the operations described herein.

### DETAILED DESCRIPTION

The following is intended to provide a detailed description of an example of the invention and should not be taken to be limiting of the invention itself. Rather, any number of variations may fall within the scope of the invention which is defined in the claims following the description.

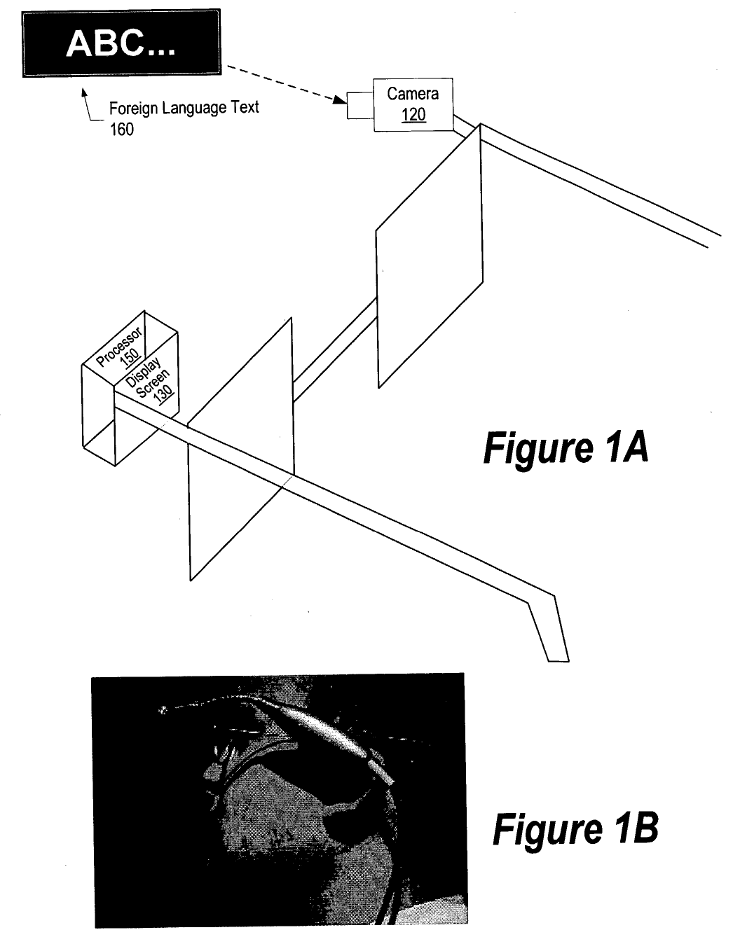

FIG. 1A is diagram of a portable eyeglass system for translating text in a first (foreign) language to a second (familiar) language. Foreign language text 160 may be a sign, menu, or other form of printed text in a foreign language. Camera 120, which may be attached to a pair of eyeglasses, is operable to capture an image containing foreign language text 160 and send the image to processor 150. Processor 150 is operable to receive the captured image, determine the zones of text, perform optical character recognition (OCR) to convert the textual image to text characters, and translate the recognized text characters to text characters in the familiar language. Processor 150 may also convert the translated text characters to an image for displaying on display screen 130. In addition, processor 150 may synthesize the translated text characters into speech for playing through a speaker.

FIG. 1B is picture of a portable eyeglass system for translating text in a first (foreign) language to a second (familiar) language. The system may comprise a camera for capturing images containing text in a foreign language, a processor for recognizing and translating the text to a familiar language, a display for viewing an image of the translated text, and an earpiece for listening to synthesized speech of the translated text. The system is shown here attached to a pair of eyeglasses.

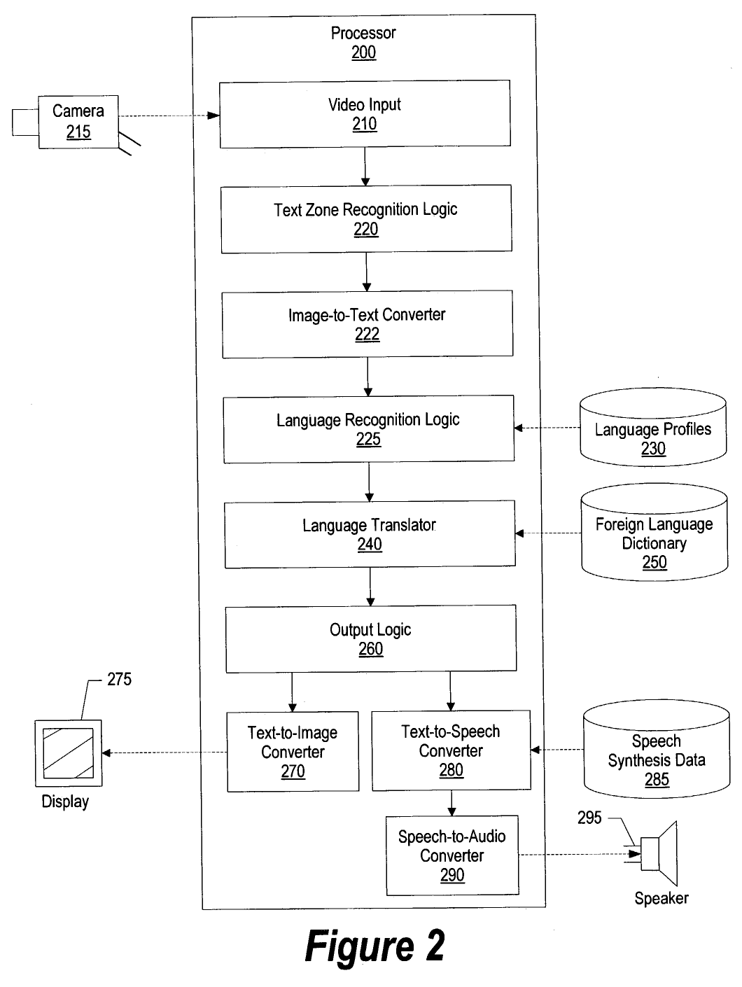

FIG. 2 is a high-level block diagram of a language translation system. The system is capable of translating text from a first (foreign) language to a second (familiar) language. Camera 215 is operable to capture an image containing text in the first language. The image may be of, for example, a sign in a public place, a menu in a restaurant, text on a map, pages in a business document such as a contract, etc. Camera 215 then sends the image to video input 210 of processor 200. Video input 210 may, after receiving the captured image, convert the image to an appropriate format. For example, Video input 210 may convert the received image from analog to a digital format. Video input 210 then sends the captured image to text zone recognition logic 220. Text zone recognition logic 220 first determines the text zone or zones (the areas where alphanumeric information is located) in the image. Text zone recognition logic 220 then sends the image and the text zone information to image-to-text converter 222.

Image-to-text converter 222 performs optical character recognition (OCR) on the text zones to obtain the text characters in digital format (such as ASCII or Unicode, for example). The recognized characters are sent to language recognition logic 225, which is responsible for identifying the language of the recognized characters (the first language). If the user has not provided a first language, language recognition logic 225 loads different language profiles from language profiles database 230 and compares these profiles against the recognized text characters to determine the language of the text characters.

Once the first language has been determined, this information and the recognized characters are sent to language translator 240 that is operable to convert these characters to a second language, typically a language with which the user is familiar. To accomplish the translation, language translator 240 loads the appropriate first language-to-second language dictionary from foreign language dictionary database 250. Language translator 240 generates text characters in the second language that are sent to output logic 260. Output logic 260 sends the generated characters either to text-to-image converter 270, or text-to-speech converter 280, or both depending on the user's request. Text-to-image converter 270 is operable to receive the generated characters and convert the generated characters to a video image that may be displayed for the user on display 275. In addition, output logic 260 may send the generated characters to text-to-speech converter 280. Text-to-analog converter 280 is operable to receive speech synthesis information from speech synthesis database 285 and synthesize the text characters into speech. The speech may be then sent to speaker 295 after being converted to audio by speech-to-audio converter 290. The user may listen to the translation as a spoken language.

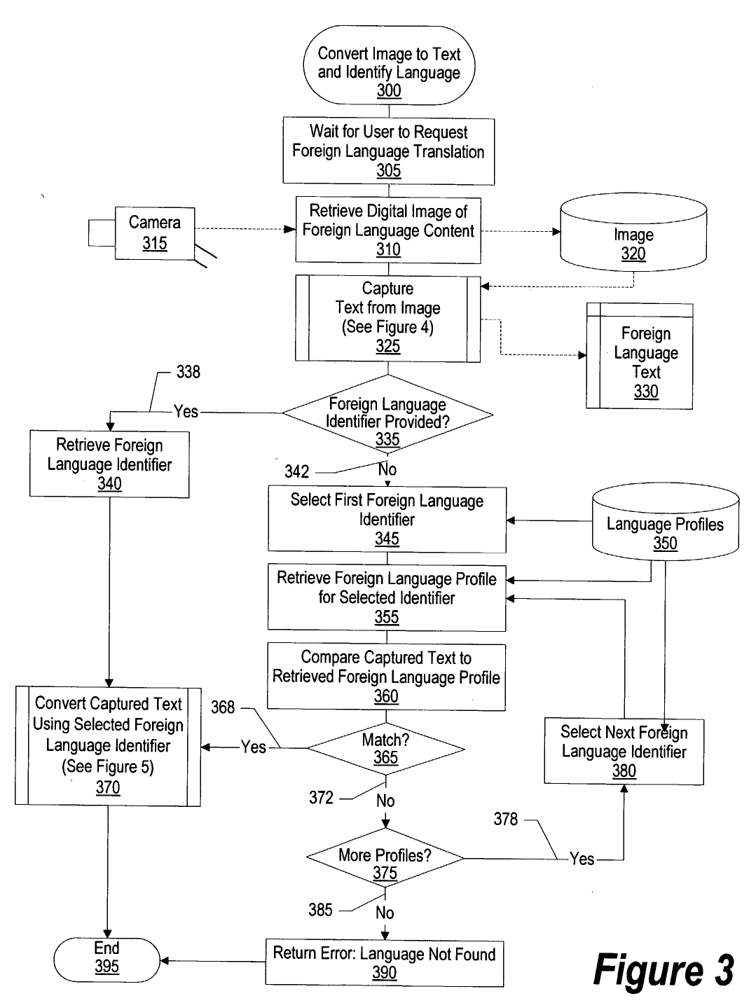

FIG. 3 is a flowchart converting the image to text characters and for identifying the foreign language. Processing commences at 300 where, in step 305, the system waits for the user to request foreign language translation. When the system receives such a request from the user, in step 310, an image containing the text to be translated is retrieved from camera 315 that has captured the image. After retrieval of the image, the image is stored in an appropriate format in image storage 320. If the captured image is in analog format, analog-to-digital conversion of the image may also be necessary at this step.

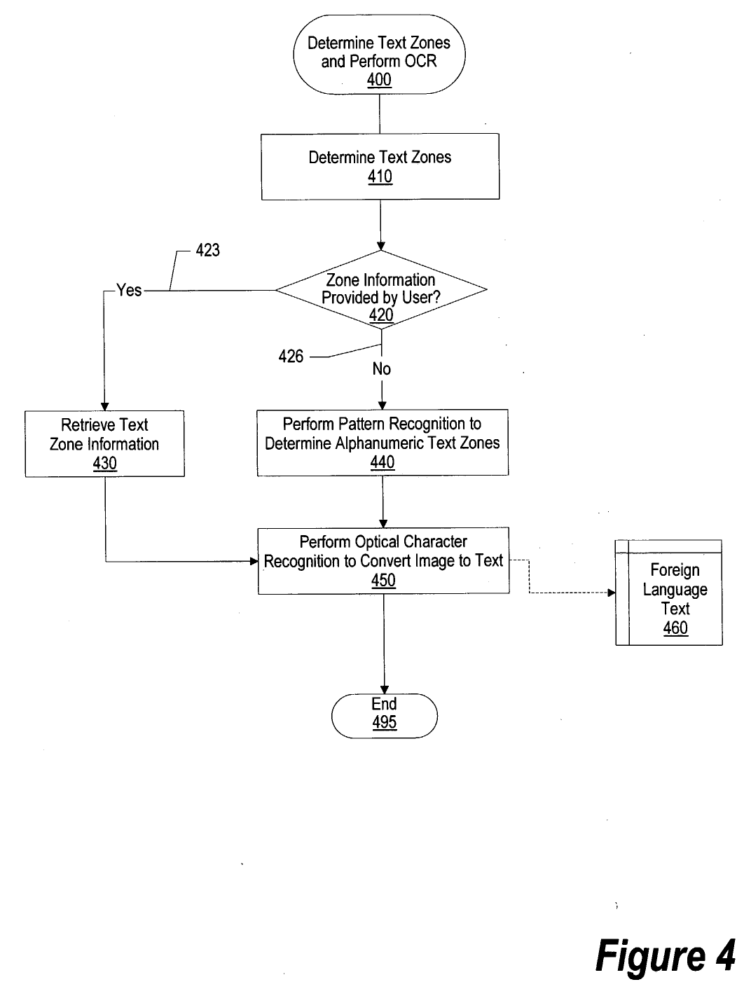

In step 325, the captured image is converted to text characters. More detail about the processing taking place at this step is provided in FIG. 4. The recognized characters are stored in foreign language text storage 330. At decision 335, a determination is made as to whether the user has provided a foreign language (first language) identifier. If the user has provided such an identifier, decision 335 branches to “yes” branch 338, and in step 340, the foreign language identifier provided by the user is retrieved. In step 370 (which is described in more detail in FIG. 4), the identified characters are converted to the second language (which was determined by the retrieved language identifier). The processing ends at 395.

If the user has not provided a foreign language identifier, decision 335 branches to “no” branch 342. In step 345, the first foreign language identifier is selected from language profiles database 350. In step 355, the language profile corresponding to the foreign language identifier is retrieved from language profiles database 350, and in step 360, the captured text is compared to the retrieved language profile. A determination is then made as to whether the captured text matches the retrieved language profile (decision 365). If the two match, decision 365 branches to “yes” branch 368, and in step 370, the captured text is converted to the second language according to the selected foreign language identifier. If the captured text does not match the retrieved language profile, decision 365 branches to “no” branch 372. A determination is then made as to whether more profiles exist in the database that have not yet been tested (decision 375). If more profiles exist, decision 375 branches to “yes” branch 378, an in step 380, the next foreign language identifier is selected and the corresponding language profile is loaded from language profile database 350. The process returns to step 355 to determine whether the newly-retrieved language matches the captured text. If there are no more language profiles, decision 375 branches to “no” branch 385, and in step 390, the error text “Language not found” is returned to the user. Processing ends at 395.

FIG. 4 is a flowchart for determining the text zones in the captured image and for performing OCR on the identified text zones to obtain text characters. Processing begins at 400 where, in step 410, the text zones in the captured image—the areas where alphanumeric information is located—are determined. A determination is then made as to whether text zone information was provided by the user (decision 420). If the user has provided such information, decision 420 branches to “yes” branch 423, and in step 430, the user-provided text zone information is retrieved. If the user has not provided any text zone information, decision 420 branches to “no” branch 426, and in step 440, pattern recognition is performed on the captured image to determine the zones with alphanumeric information.

In step 450, OCR is performed on the identified text zones to convert the textual images to text characters. After recognition, the text characters are stored in foreign language text storage 460. The processing ends at 495.

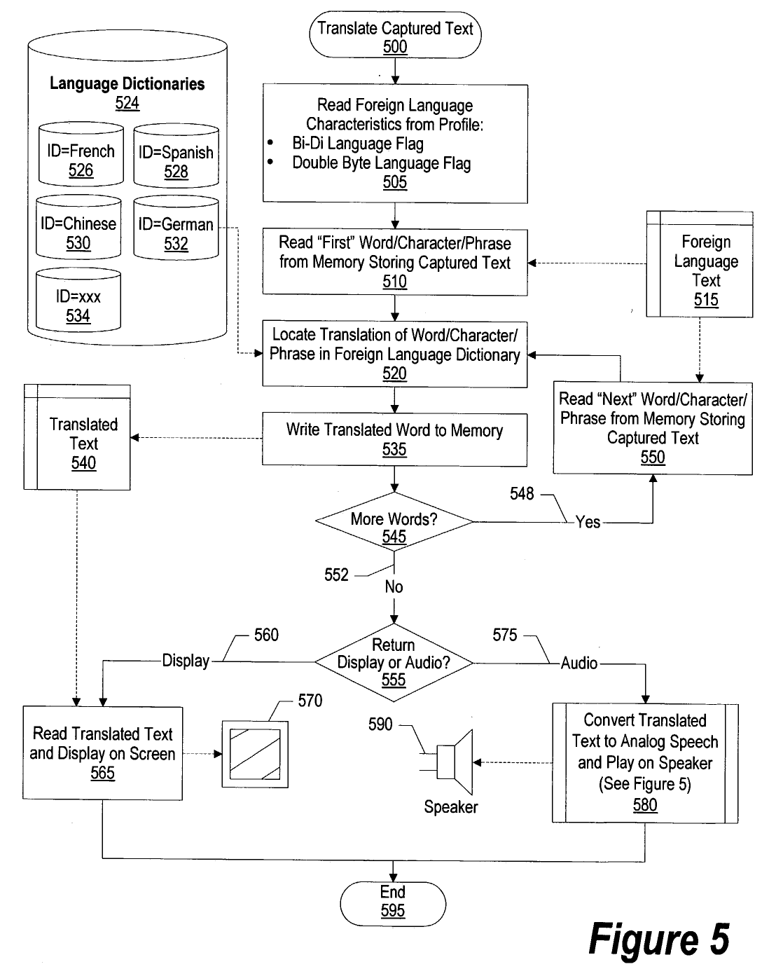

FIG. 5 is a flowchart for translating captured text in a determined first language to text in a known second language. Processing begins at 500 where, in step 505, the foreign language (first language) characteristics are read from the corresponding language profile. In step 510, the “first” word/character/phrase is read from foreign language text storage 515. The translation of the word/character/phrase is then located in language dictionaries 524. Language dictionaries 524 may contain one or more language dictionaries such as dictionaries 526-434. Depending on the foreign language, the translation of the word, character, or phrase will be located in the appropriate dictionary. For example, if the foreign language is German, the translation will be located in German dictionary 532.

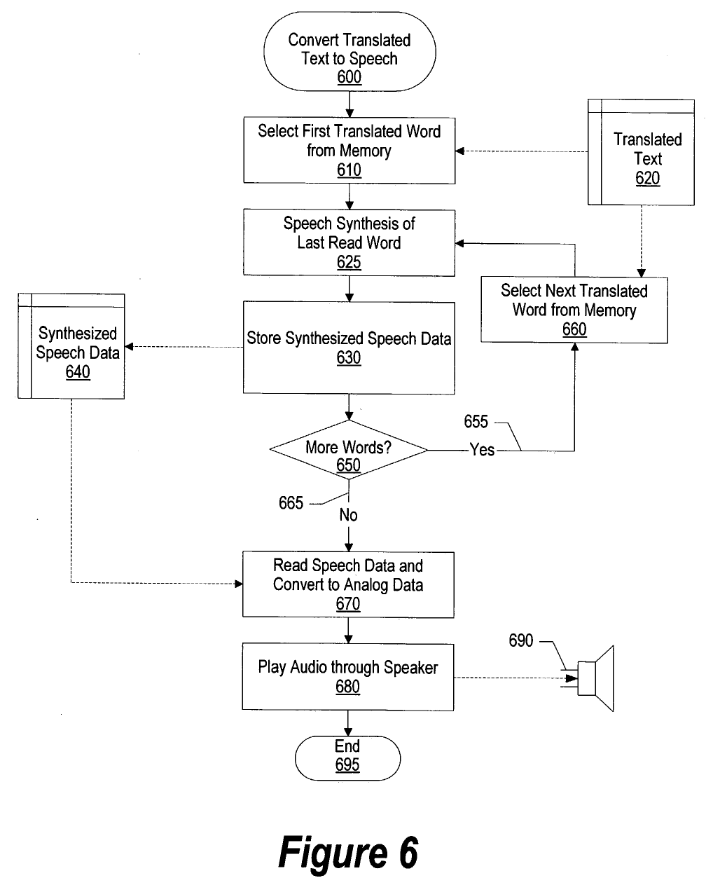

In step 535, the translated word, character, or phrase is stored in translated text storage 540. A determination is then made as to whether more words, characters, or phrases exist in the captured text requiring translation (decision 545). If more words, characters, or phrases exist, decision 545 branches to “yes” branch 548, and in step 550, the next word, character, or phrase is read from foreign language text storage 515. The process then returns to step 520 to continue the translation. If no more words, characters, or phrases exist in the captured text, decision 545 branches to “no” branch 552. A determination is then made as to whether to return video, audio, or both to the user (decision 555). If video is to be returned, decision 555 branches to “display” branch 560, and in step 565, the translated text is read from translated text storage 540 and displayed on display 570. If audio is to be returned, decision 555 branches to “audio” branch 575, and in step 580 (shown in more detain in FIG. 6), the translated text is converted to analog speech and played over speaker 590. If both text and audio are to be returned, then both branches (560 and 575) are performed. Processing ends at 595.

FIG. 6 is a flowchart for converting the translated text to speech. Processing commences at step 600 where, in step 610, the first translated word is selected from translated text storage 620. In step 625, the last read word is synthesized into speech, and in step 630 the speech data is stored into synthesized speech data storage 640. A determination is then made as to whether more words exist in the translated text requiring conversion into speech (decision 650). If more words exist, decision 650 branches to “yes” branch 655, and in step 660, the next word is selected from translated text storage 620. Processing then returns to step 625 for more text-to-speech conversion.

If there are no more words to be converted, decision 650 branches to “no” branch 665, and in step 670, the stored speech data is read from synthesized speech data storage 640 and converted to analog audio. In step 680, the generated audio is played over speaker 690. Processing ends at 695.

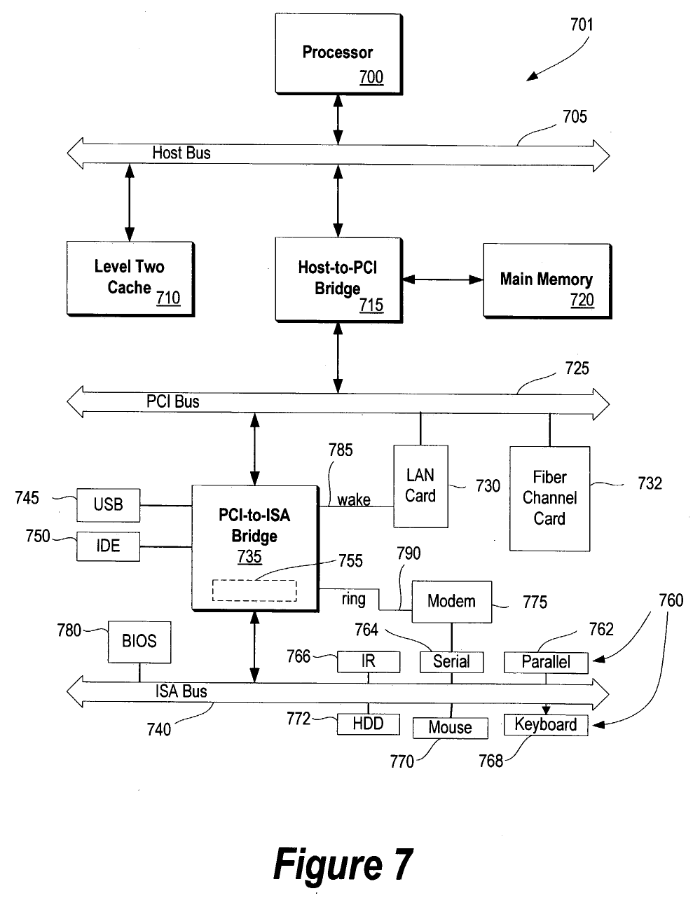

FIG. 7 illustrates information handling system 701 which is a simplified example of a computer system capable of performing the operations described herein. Computer system 701 includes processor 700 which is coupled to host bus 705. A level two (L2) cache memory 710 is also coupled to the host bus 705. Host-to-PCI bridge 715 is coupled to main memory 720, includes cache memory and main memory control functions, and provides bus control to handle transfers among PCI bus 725, processor 700, L2 cache 710, main memory 720, and host bus 705. PCI bus 725 provides an interface for a variety of devices including, for example, LAN card 730. PCI-to-ISA bridge 735 provides bus control to handle transfers between PCI bus 725 and ISA bus 740, universal serial bus (USB) functionality 745, IDE device functionality 750, power management functionality 755, and can include other functional elements not shown, such as a real-time clock (RTC), DMA control, interrupt support, and system management bus support. Peripheral devices and input/output (I/O) devices can be attached to various interfaces 760 (e.g., parallel interface 762, serial interface 764, infrared (IR) interface 766, keyboard interface 768, mouse interface 770, fixed disk (HDD) 772 coupled to ISA bus 740. Alternatively, many I/O devices can be accommodated by a super I/O controller (not shown) attached to ISA bus 740.

BIOS 780 is coupled to ISA bus 740, and incorporates the necessary processor executable code for a variety of low-level system functions and system boot functions. BIOS 780 can be stored in any computer readable medium, including magnetic storage media, optical storage media, flash memory, random access memory, read only memory, and communications media conveying signals encoding the instructions (e.g., signals from a network). In order to attach computer system 701 to another computer system to copy files over a network, LAN card 730 is coupled to PCI bus 725 and to PCI-to-ISA bridge 735. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method for translating text using a portable translation device, the method comprising:
capturing an image at the portable translation device, wherein the image contains text in a first language;
converting the text in the image to text characters;
translating the text characters to a second language; and
providing the translation to a user through an output device accessible from the portable translation device.

2. The method of claim 1, wherein the converting the text comprises:
identifying one or more zones in the image containing text; and
performing optical character recognition (OCR) on the identified zones to obtain the text characters.

3. The method of claim 2, wherein the identifying one or more zones comprises receiving user input indicating the text zones.

4. The method of claim 2, wherein the identifying one or more zones comprises performing pattern recognition to identify textual areas in the image.

5. The method of claim 1, wherein the translating comprises:
selecting one word from the text characters;
locating a translation of the word in a first language-to-second language foreign language dictionary; and
storing the translation of the word in a memory location.

6. The method of claim 1, further comprising determining one or more zones in the image containing text in the first language.

7. The method of claim 1 further comprising:
identifying the first language before the converting;
comparing the text characters to known language profiles;
matching the text characters to one language profiles; and
identifying the first language as the language whose profile matched.

8. The method of claim 1 wherein the output device is selected from the group consisting of a display screen and a speaker, the method further comprising:
if the output device is the display screen:
converting the text characters to an output image; and
displaying the output image on the display screen; and
if the output device is the speaker:
synthesizing the text characters into speech; and
playing the synthesized speech to a user through the speaker.

9. An information handling system comprising:
one or more processors;
a memory accessible by the processors;
one or more nonvolatile storage devices accessible by the processors;
a video camera that captures an image, wherein the image contains text in a first language;
a converter that converts the text in the image to text characters;
a translator that translates the text characters to a second language; and
an output device that provides the translation to the user.

10. The information handling system of claim 9, wherein the converter further comprises:
one or more zones in the image containing text; and
optical character recognition logic that operates on the identified zones to obtain the text characters.

11. The information handling system of claim 9, wherein the translator further comprises:
a selector that selects one word from the text characters;
a translation lookup table that includes a plurality of foreign language words; and
an output processor that stores the translation of the word in the memory.

12. The information handling system of claim 9 further comprising:
a selection that identifies the first language before the converter converts the text;
a comparator that compares the text characters to known language profiles, wherein the first language is the language whose language profile matched the text characters.

13. The information handling system of claim 9 wherein the output device is selected from the group consisting of a display screen and a speaker, the information handling system further comprising:
if the output device is a display screen:
an image converter that converts the text characters to an output image that is displayed on the display screen; and
if the output device is a speaker:
a synthesizer that synthesizes the text characters into speech that is played through the speaker.

14. A computer program product stored on a computer operable media for translating text, said computer program product comprising:
means for capturing an image at a portable translation device, wherein the image contains text in a first language;
means for converting the text in the image to text characters;
means for translating the text characters to a second language; and
means for providing the translation to a user through an output device accessible from the portable translation device.

15. The computer program product of claim 14, wherein the means for converting the text further comprises:
means for identifying one or more zones in the image containing text; and
means for performing optical character recognition (OCR) on the identified zones to obtain the text characters.

16. The computer program product of claim 15, wherein the means for identifying one or more zones comprises a means for performing pattern recognition to identify textual areas in the image.

17. The computer program product of claim 14, wherein the means for translating further comprises:
means for selecting one word from the text characters;
means for locating a translation of the word in a first language-to-second language foreign language dictionary; and
means for storing the translation of the word in a memory location.

18. The computer program product of claim 14, further comprising:
means for determining one or more zones in the image containing text in the first language.

19. The computer program product of claim 14 further comprising:
means for identifying the first language before the converting;
means for comparing the text characters to known language profiles;
means for matching the text characters to one language profiles; and
means for identifying the first language as the language whose profile matched.

20. The computer program product of claim 14 wherein the output device is selected from the group consisting of a display screen and a speaker, the computer program product further comprising:
if the output device is a display screen:
means for converting the text characters to an output image; and
means for displaying the output image to the display screen; and
if the output device is a speaker:
means for synthesizing the text characters into speech; and
means for playing the synthesized speech to a user through the speaker.
